(19) United States
(12) Patent Application Publication
(10) Pub. No.: US 2011/0043960 A1
(43) Pub. Date: Feb. 24, 2011

(54) PROGRAMMABLE ACTUATOR AND PROGRAMMING METHOD THEREOF

(75) Inventor: Tamio Ikehashi, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/859,516

(22) Filed: Aug. 19, 2010

(30) Foreign Application Priority Data
Aug. 20, 2009 (JP) 2009-191261

(51) Int. Cl. H01H 59/00; H01G 7/00

(52) U.S. Cl. 361/207; 361/277

(57) ABSTRACT

According to one embodiment, a programmable actuator includes a moving part with a first drive electrode, a second electrode which is placed opposite to the first electrode and which has first part and a second part, a first drive circuit which is available to operate the moving part one or more times in such a way that the first drive electrode is apart from the second part by generating a first electric potential difference between the first part and the first drive electrode, and a second drive circuit which is available to fix the moving part in such a way that the first drive electrode is in contact with the second part by generating a second electric potential difference between the second part and the first drive electrode.

### CROSS-REFERENCE TO RELATED APPLICATION

This application is based upon and claims the benefit of priority from the prior Japanese Patent Application No. 2009-191261, filed Aug. 20, 2009, the entire contents of which are incorporated herein by reference.

### FIELD

Embodiments described herein relate generally to a programmable actuator and a programming method thereof.

### BACKGROUND

Micro-electromechanical Systems (MEMS) actuators are used for variable capacitor elements, switch elements, etc. In these cases, MEMS actuators are required to stably repeat an operation of moving a moving part after shipping.

### BRIEF DESCRIPTION OF THE DRAWINGS

FIG. 1 illustrates a basic structure.

FIG. 2 illustrates a programming method.

FIG. 3 is a plane view illustrating a first embodiment.

FIG. 4 is a cross sectional view along with IV-IV.

FIG. 5 is a cross sectional view along with V-V.

FIGS. 6 and 7 illustrate lower drive electrodes respectively.

FIG. 8 illustrates a normal operation.

FIG. 9 illustrates a programming operation.

FIG. 10 illustrates a second embodiment.

FIG. 11 illustrates a capacity bank.

FIG. 12 illustrates biases in a capacity bank.

FIG. 13 illustrates a bias line in common.

FIG. 14 illustrates a third embodiment.

FIG. 15 illustrates a normal operation.

FIG. 16 illustrates a programming operation.

FIG. 17 illustrates a fourth embodiment.

FIGS. 18 and 19 illustrate lower drive electrodes respectively.

FIG. 20 illustrates a normal operation.

FIG. 21 illustrates a programming operation.

FIG. 22 illustrates a fifth embodiment.

FIG. 23 illustrates a programmable inductor.

FIG. 24 illustrates a programmable resistor.

FIG. 25 illustrates a sixth embodiment.

### DETAILED DESCRIPTION

Meanwhile, MEMS actuators may be used to trim a capacitance and/or a resistance before shipping. In this case, MEMS actuators are required to stably repeat an operation of moving a moving part and to function to store a capacitance and/or a resistance.

A trimmer capacitor which trims a capacitance will now be described below.

Trimmer capacitors are used in crystal oscillators and keyless entry systems, to suppress output frequencies within a specified range before shipping.

A first example of trimmer capacitors will be of a type which rotates a semi-circular electrode by a drive circuit to vary and store a capacitor value. However, this type requires a large size, and allows a capacitance to be easily varied by vibration and heat.

A second example of trimmer capacitors will be of a type which varies and stores a capacitance by removing a part of an electrode by a laser. This type is named a laser trimmable capacitor. However, this type requires a large-scale system comprising a laser light source. In addition, partial removal of an electrode by a laser is a irreversible process, and an original capacitance can therefore not be recovered again once the electrode is removed too much.

Under these circumstances, discussions have been made to use an electrostatic MEMS actuator which drives a moving part by an electrostatic force, for trimming of a capacitance and/or a resistance before shipping.

In this case, the electrostatic MEMS actuator is required to stably repeat an operation of moving a moving part by the electrostatic force (attractive/repulsive force), and to function to store a capacitance by thereafter moving the moving part to a predetermined position by an electrostatic force.

However, the electrostatic force need be continuously applied to electrostatically move and maintain the moving part to and at a predetermined position.

This gives rise to a demand for development in an electrostatic MEMS actuator which has a programmed function capable of storing states (e.g., a capacitance, on/off of a switch, etc.) without using an electrostatic force.

In general, according to one embodiment, a programmable actuator comprises a moving part with a first drive electrode, a second electrode which is placed opposite to the first electrode and which has a first part and a second part, a first drive circuit which is capable of actuating the moving part in such a way that the first drive electrode is not in contact with the second part by generating a first electric potential difference between the first part and the first drive electrode, and a second drive circuit which is capable of fixing the moving part in such a way that the first drive electrode is in contact with the second part by generating a second electric potential difference between the second part and the first drive electrode.

1. Basic Structure

Embodiments describe electrostatic MEMS actuators which have a program function to trim a capacitance and/or a resistance before shipping.

To “have a program function” means that a moving part can be permanently fixed. An ordinary electrostatic MEMS actuator does not permanently fix its moving part. The electrostatic MEMS actuator in each embodiment is referred to as a programmable actuator to distinguish itself from the aforementioned ordinary electrostatic MEMS actuator.

To “permanently fix” means an irreversible operation which cannot be recovered even by removing or applying any acting force, such as an electrostatic force, after fixation is once performed. Accordingly, for example, temporary fixation owing to an electrostatic force during a normal operation of MEMS cannot be said to be permanent fixation. The permanent fixation does not exclude release of fixation when an extremely strong force is applied except during the normal operation.

A basic structure of the programmable actuator will now be described.

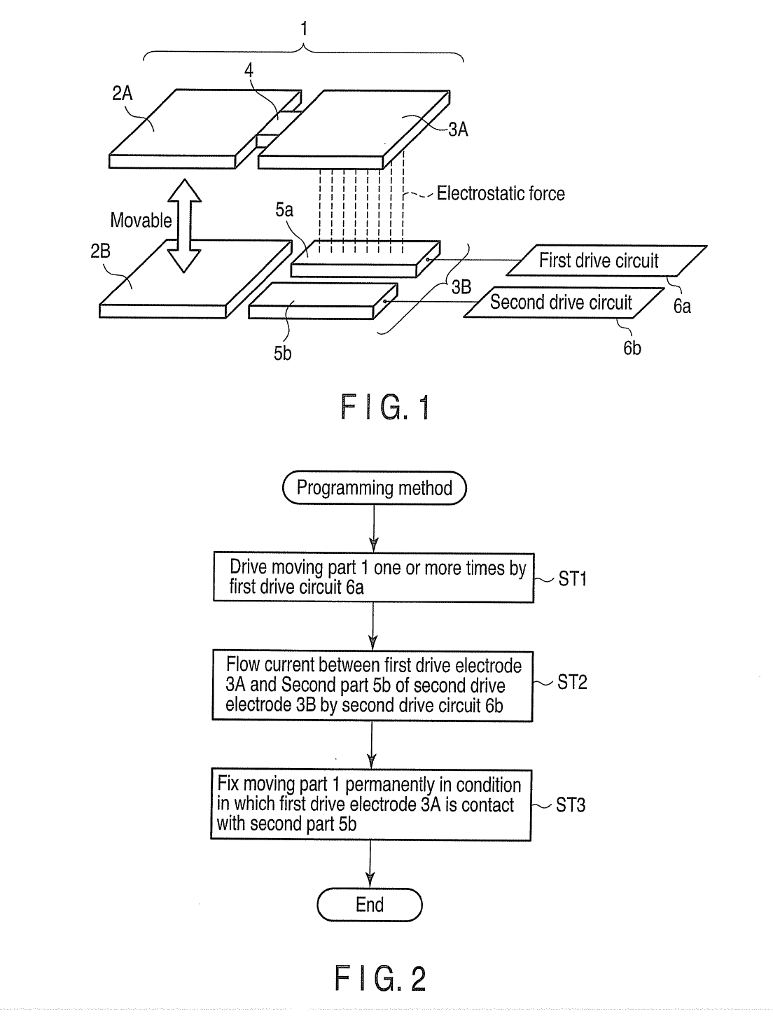

FIG. 1 illustrates the basic structure of the programmable actuator.

Moving part 1 comprises first signal electrode 2A, first drive electrode 3A, and insulator 4 which joints the electrodes 2A and 3A. Second signal electrode 2B is placed opposite to the first signal electrode 2A, and second drive electrode 3B is placed opposite to the first drive electrode 3A.

Second drive electrode 3B comprises first and second parts 5a and 5b.

First drive circuit 6a is connected to first part 5a of the second drive electrode 3B, and second drive circuit 6b is connected to second part 5b of second drive electrode 3B.

First drive circuit 6a generates a first potential (electrostatic force) between first part 5a of second drive electrode 3B and first drive electrode 3A, thereby to operate moving part 1 plural times, with part 5a and electrode 3A put out of in contact with each other.

Second drive circuit 6b generates a second potential (electrostatic force) between second part 5b of second drive electrode 3B and first drive electrode 3A, thereby to fix the moving part, with part 5a and electrode 3A put in contact with each other.

According to the configuration as described above, during trimming before shipping, moving part 1 can be operated plural times by first drive circuit 6a, and moving part 1 can be fixed, with the first drive electrode 3A put in contact with second part 5b by second drive circuit 6b.

Accordingly, the electrostatic MEMS actuator can be equipped with a program function, and for example, trimming is available before shipping. In addition, downsizing and cost down are available based on the electrostatic MEMS actuator.

The basic structure in FIG. 1 puts no limitations to positional relationships between top, bottom, left, and right sides. For example, electrodes 2A and 3A, as well as electrodes 2B and 3B, may be located either in the positional relationship of top and bottom sides or the positional relationship of the left and right sides. In this case, any one of each pair of electrodes can be located either in the top (or left) side or bottom (or right) side.

FIG. 2 represents a programming method for the programmable actuator in FIG. 1.

At first, moving part 1 is operated plural times by first drive circuit 6a (step ST1).

Here, for example, when to trim a capacitance before shipping, plural programmable actuators are grouped into a bank. Further, the respective actuators in the bank is driven to generate various capacitances from which an optimal value is selected.

To generate such various capacitances, moving part 1 need be operated plural times.

Next, a current is flowed between second part 5b of second drive electrode 3B and first drive electrode 3A, with part 5a and electrode 3A put in contact with each other by second drive circuit 6b (step ST2).

Second part 5b of second drive electrode 3B and first drive electrode 3A are brought into contact with each other in a method as follows.

For example, first drive circuit 6a may be used to generate a potential (electrostatic force) between first part 5a of second drive electrode 3B and first drive electrode 3A. Alternatively, second drive circuit 6b may be used to generate a potential (electrostatic force) between second part 5b of second drive electrode 3B and first drive electrode 3A. Still alternatively, both circuits may be used together.

Next, moving part 1 is fixed, with second part 5b of second drive electrode 3B and first drive electrode 3A put in contact with each other (step ST3).

This fixation is achieved by fixing first drive electrode 3A to second part 5b. For example, a current which is flowed between second part 5b of second drive electrode 3B and first drive electrode 3A may be set to such a value that partially malts <halts?> part 5a and first drive electrode 3A.

Alternatively, moving part 1 may be fixed by van der Waals's force or Casimir force.

According to methods as described above, the programmable actuator can be programmed simply at low costs.

2. Embodiments

I. First Embodiment

A. Device Structure

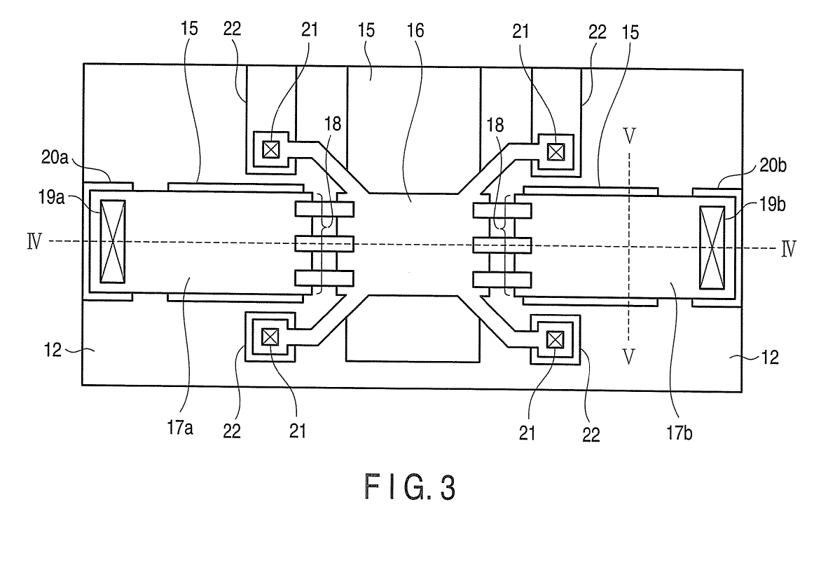

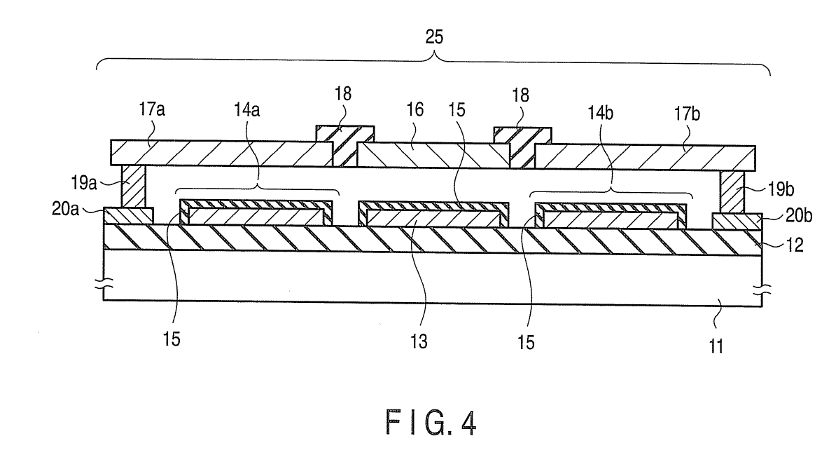

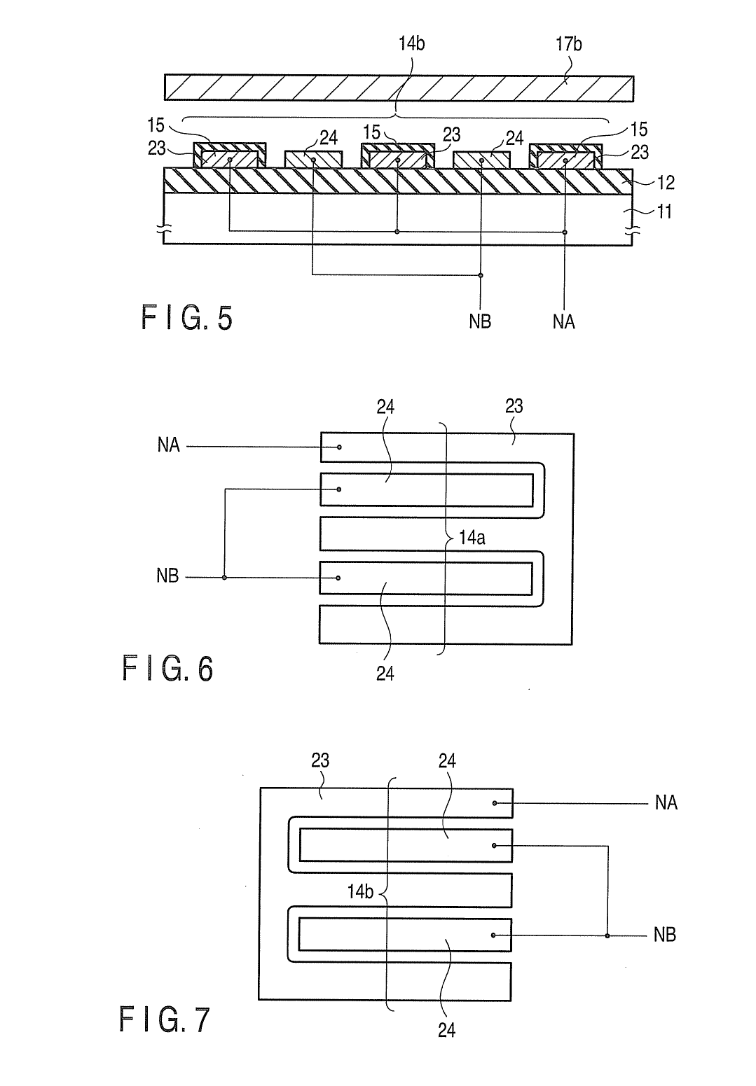

FIG. 3 is a plane view of the programmable actuator. FIG. 4 is a cross sectional view along line IV-IV in FIG. 3. FIG. 5 is a cross sectional view along line V-V in FIG. 3.

A semiconductor substrate 11 is, for example, a silicon substrate. An insulating layer 12 is provided on the semiconductor substrate 11. Insulating layer 12 is made of, for example, silicon oxide.

Lower signal electrode 13, lower drive electrodes 14a and 14b, and conductive layers 20a, 20b, and 22 are provided on the insulating layer 12.

Lower signal electrode 13 is covered with insulating layer 15.

Lower drive electrodes 14a and 14b each comprise first part 23 and second part 24. First part 23 and second part 24 are arranged alternately. First part 23 is covered with insulating layer 15.

Lower drive electrode 14a has a plan shape as illustrated in FIG. 6, for example. Lower drive electrode 14b has a plan shape as illustrated in FIG. 7.

Upper signal electrode 16 opposite to lower signal electrode 13 is provided above lower signal electrode 13.

Upper drive electrodes 17a and 17b opposite to lower drive electrodes 14a and 14b are provided above lower drive electrodes 14a and 14b.

Upper signal electrode 16 and upper drive electrodes 17a and 17b are jointed mutually by an insulator 18. Moving part 25 is constituted by upper signal electrode 16, upper drive electrodes 17a and 17b, and insulator 18 combining these electrodes.

Upper signal electrode 16 is connected to conductive layer 22 through anchor 21.

An end of upper drive electrode 17a is connected to conductive layer 20a through anchor 19a. An end of upper drive electrode 17b is connected to conductive layer 20b through anchor 19b.

NA denotes a potential generated by a first drive circuit (corresponding to first drive circuit 6a in FIG. 1). NB denotes a potential generated by a second drive circuit (corresponding to second drive circuit 6b in FIG. 1).

For first part 23 and second parts 24 of lower drive electrodes 14a and 14b, potentials can be independently biased.

Meanwhile, this structure is applicable to when the programmable actuator is used as a programmable capacitor. For example, when the programmable actuator is used as a programmable switch, lower signal electrode 13 may be removed from the structure illustrated in FIGS. 3 to 7.

B. Normal Operation

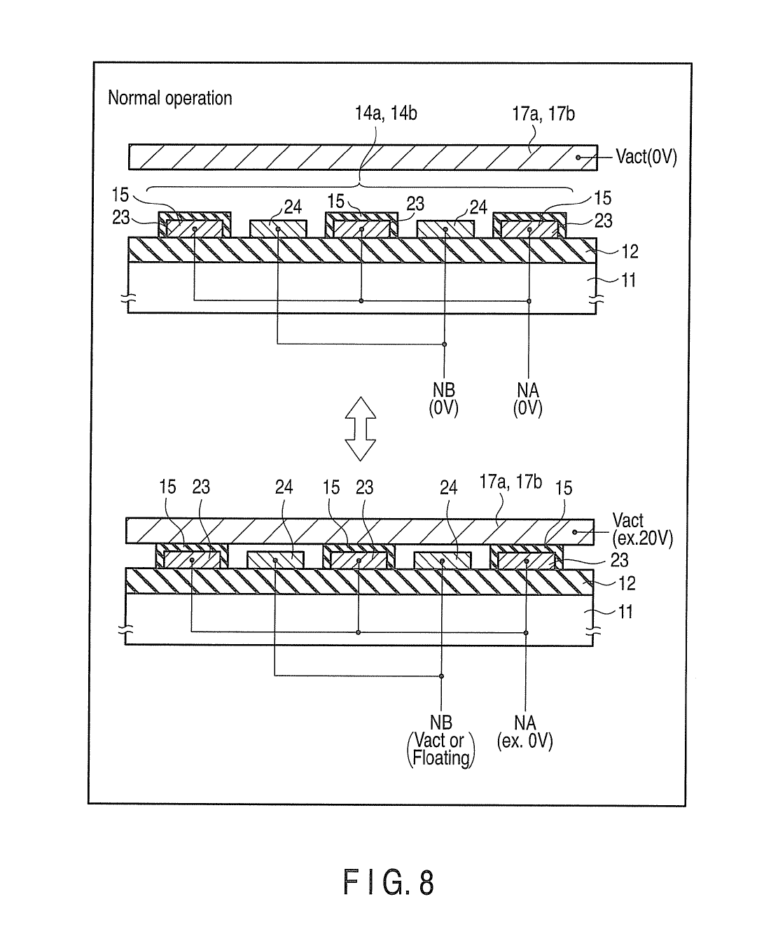

FIG. 8 illustrates a normal operation of the programmable actuator.

The normal operation means an operation with the moving part not fixed.

In an initial state, potential NA of first parts 23 of lower drive electrodes 14a and 14b is set to zero, and potential NB of second parts 24 of lower drive electrodes 14a and 14b is also set to zero. Potential Vact of upper drive electrodes 17a and 17b is set to zero.

At this time, a distance between the lower and upper signal electrodes is maximum. Therefore, for example, the programmable actuator as the programmable capacitor has a minimum capacitance, and as a programmable switch enters into an off-state.

In a drive state of driving the moving part, for example, potential NA of first parts 23 of lower drive electrodes 14a and 14b is set to zero, and potential NB of second parts 24 of lower drive electrodes 14a and 14b is set to Vact or floating. Potential Vact of upper drive electrodes 17a and 17b is set to 20 V.

At this time, an electrostatic attractive force is generated between first parts 23 of lower drive electrodes 14a and 14b and upper drive electrodes 17a and 17b. Therefore, upper drive electrodes 17a and 17b are attracted to first parts 23 of lower drive electrodes 14a and 14b.

As a result, the distance between the upper and lower signal electrodes is minimized or becomes zero (contact state). Therefore, the capacitance of the programmable actuator as a programmable capacitor takes a maximum value, and the programmable actuator as a programmable switch enters into an on-state.

The operation described above is carried out with first parts 23 of lower drive electrodes 14a and 14b and upper drive electrodes 17a and 17b put out of in contact with each other. Therefore, the operation can be stably performed plural times by controlling values of NA, NB, and Vact.

Alternatively in the drive state of driving the moving part, for example, potential NA of first parts 23 of lower drive electrodes 14a and 14b may be set to 20 V, and potential NB of second parts 24 of lower drive electrodes 14a and 14b and potential Vact of upper drive electrodes 17a and 17b may be set to zero.

C. Programming Operation

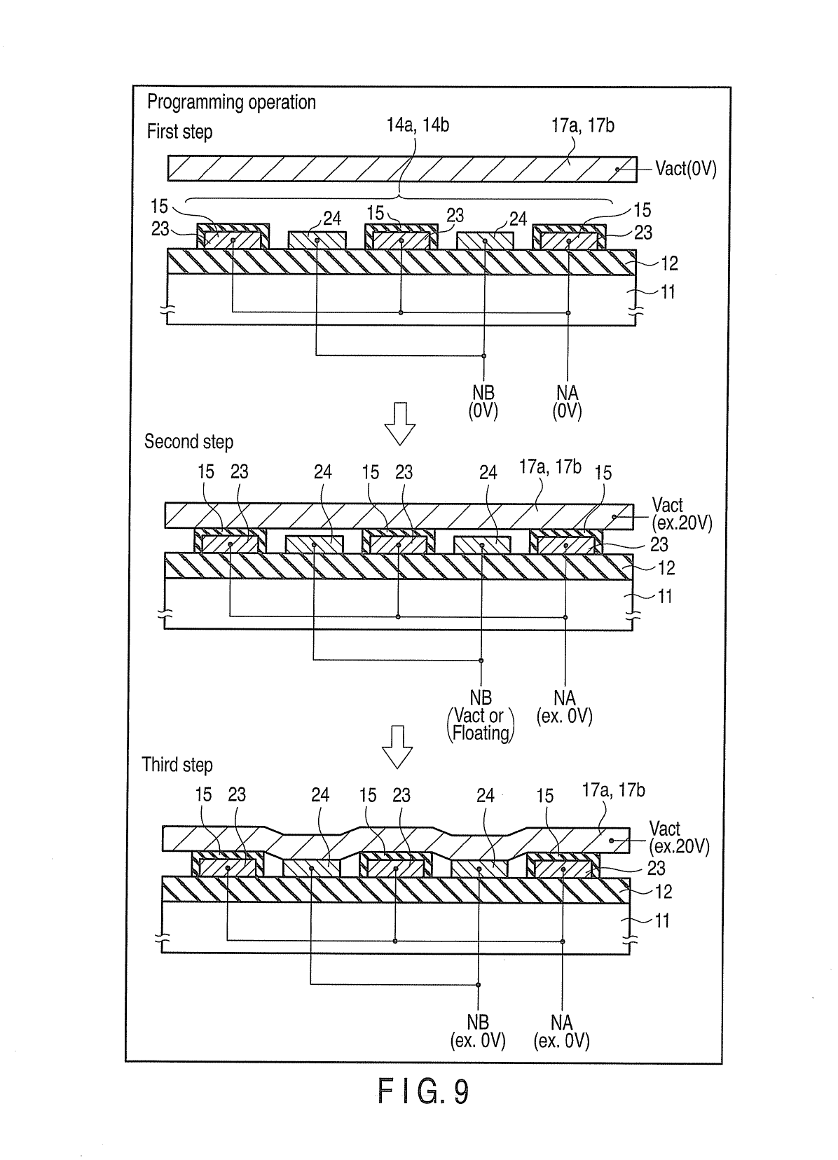

FIG. 9 illustrates a programming operation of the programmable actuator.

The programming operation is an operation to fix the moving part.

In a first step, potential NA of first parts 23 of lower drive electrodes 14a and 14b is set to zero, and potential NB of second parts 24 of lower drive electrodes 14a and 14b is set to zero. Potential Vact of upper drive electrodes 17a and 17b is set to zero.

At this time, the distance between the lower and upper signal electrodes is maximized. Therefore, for example, a capacitance of the programmable actuator as a programmable capacitor takes a minimum value, and the programmable actuator as a programmable switch enters into an off-state.

In a second step, for example, potential NA of first parts 23 of lower drive electrodes 14a and 14b is set to zero, and potential NB of second parts 24 of lower drive electrodes 14a and 14b is set to Vact or floating. Potential Vact of upper drive electrodes 17a and 17b is set to 20 V.

At this time, an electrostatic attractive force is generated between first parts 23 of lower drive electrodes 14a and 14b and upper drive electrodes 17a and 17b. Therefore, upper drive electrodes 17a and 17b are attracted to first parts 23 of lower drive electrodes 14a and 14b.

As a result, the distance between the lower and upper signal electrodes is minimized or becomes zero (contact state). Therefore, for example, the capacitance of the programmable actuator as a programmable capacitor takes a maximum value, and the programmable actuator as a programmable switch enters into an on-state.

In a third step, for example, potential NA of first parts 23 of lower drive electrodes 14a and 14b is set to zero, and potential NB of second parts 24 of lower drive electrodes 14a and 14b is set to zero. Potential Vact of upper drive electrodes 17a and 17b is set to 20 V.

At this time, upper drive electrodes 17a and 17b are attracted to first parts 23 of lower drive electrodes 14a and 14b, and further, an electrostatic attractive force is generated between second parts 24 of lower drive electrodes 14a and 14b and upper drive electrodes 17a and 17b. Therefore, upper drive electrodes 17a and 17b make in contact with second parts 24 of lower drive electrodes 14a and 14b.

In this state, such a current that partially melts second parts 24 of lower drive electrodes 14a and 14b and upper drive electrodes 17a and 17b by heat generation is flowed between both second parts 24 and the electrodes 17a and 17b. If this current is stopped, second parts 24 of lower drive electrodes 14a and 14b and upper drive electrodes 17a and 17b are cooled, and second parts 24 and the electrodes 17a and 17b are both permanently fixed.

As a result, for example, when the capacitance of the programmable actuator as a programmable capacitor takes a maximum value or when the programmable actuator as a programmable switch is in the on-state, the moving part is fixed.

Alternatively in the second step, potential NA of first parts 23 of lower drive electrodes 14a and 14b may be set to 20 V, and potential NB of second parts 24 of lower drive electrodes 14a and 14b and potential Vact of upper drive electrodes 17a and 17b may be set to zero. In the third step, potential NA of first parts 23 of lower drive electrodes 14a and 14b and potential NB of second parts 24 of lower drive electrodes 14a and 14b may be set to 20 V. Potential Vact of upper drive electrodes 17a and 17b may be set to zero.

Also, permanent fixation between second parts 24 of lower drive electrodes 14a and 14b and upper drive electrodes 17a and 17b may be achieved by van der Waals's force or Casimir force in place of heat generation using an electric current.

In this method, the moving part is attracted in the second step, and thereafter, second parts 24 of lower drive electrodes 14a and 14b and upper drive electrodes 17a and 17b are fixed in the third step.

At this time, a voltage generated between second parts 24 of lower drive electrodes 14a and 14b and upper drive electrodes 17a and 17b may be lower than a voltage generated between first parts 23 of lower drive electrodes 14a and 14b and upper drive electrodes 17a and 17b.

This is because, in the second step, the distance between second parts 24 of lower drive electrodes 14a and 14b and upper drive electrodes 17a and 17b is sufficiently small.

According to the first embodiment, the programmable actuator can be easily programmed. Therefore, for example, capacitances and resistances can be trimmed by using the programmable actuator before shipping.

II. Second Embodiment

The second embodiment relates to a bank configuration using programmable actuators according to the first embodiment.

A. Bank Configuration

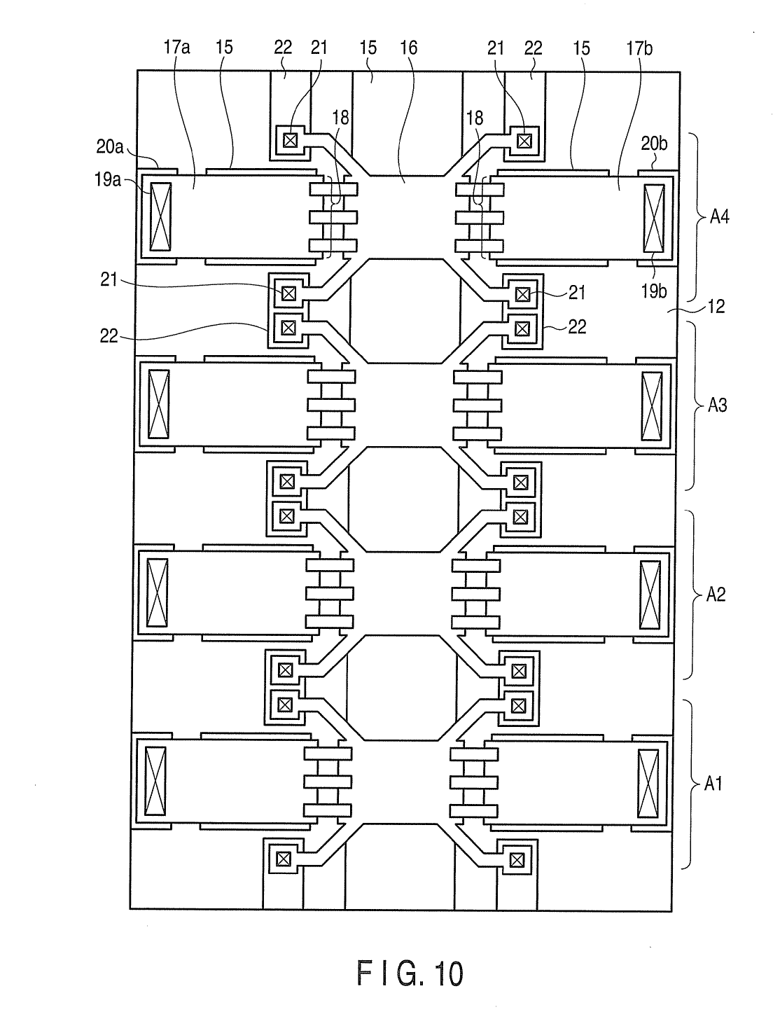

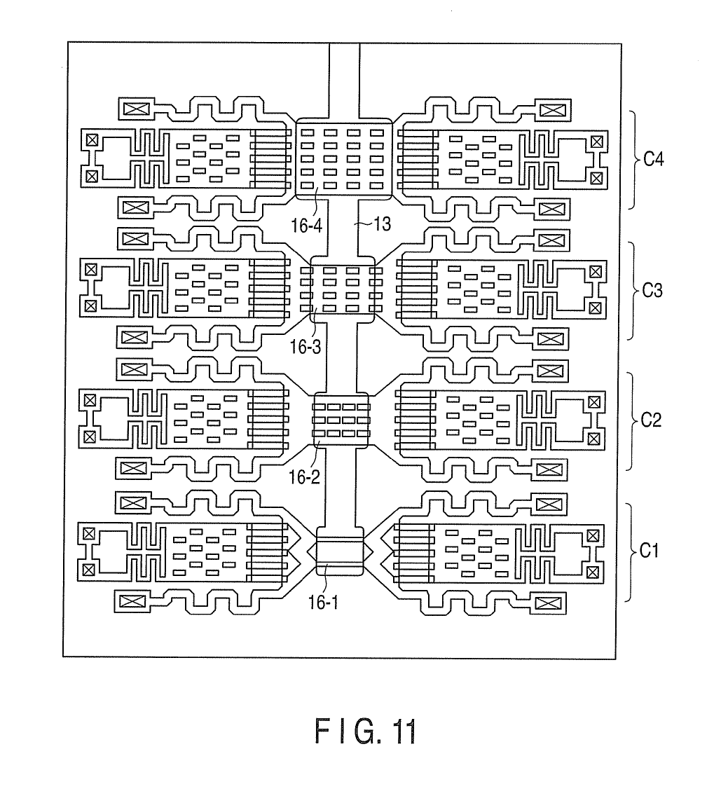

FIG. 10 illustrates an example of the bank configuration.

One bank comprises plural grouped programmable actuators. Described herein will be an example in which one bank is constituted by four programmable actuators A1, A2, A3, and A4.

Each of programmable actuators A1, A2, A3, and A4 is configured in the same structure as illustrated in FIGS. 3 to 7.

By employing such a bank configuration, the whole bank can handle n*m values even when each one actuator can handle only 1 bit data. Here, n is a number of actuators, and m is a value which can be programmed in one actuator.

Particularly when the programmable actuators are used as programmable capacitors, the whole bank can generate a greater number of capacitances if the capacitances generated by the respective actuators are made to differ from each other

For example, one programmable capacitor generates 1 bit data, and the capacitances of n programmable actuators are varied in a binary manner, such as Cmin/Cmax, 2Cmin/2Cmax, 4Cmin/4Cmax, 8Cmin/8Cmax, . . . . Then, 2ⁿ capacitances can be attained.

FIG. 11 illustrates an example of the bank configuration when the capacitances of the four programmable actuators are varied in a binary manner.

Binary variations of capacitances can be achieved by varying overlap areas between lower signal electrode 13 and upper signal electrodes 16-1, 16-2, 16-3, and 16-4.

For example, an overlap area between lower signal electrode 13 and upper signal electrode 16-1 in a programmable capacitor C1 is supposed to be “1”. Then, another overlap area is “2” between lower signal electrode 13 and upper signal electrode 16-2 in a programmable capacitor C2, and a still another overlap area is “4” between lower signal electrode 13 and upper signal electrode 16-3 in a programmable capacitor C3. Still another overlap area is “8” between lower signal electrode 13 and upper signal electrode 16-4 in a programmable capacitor C3.

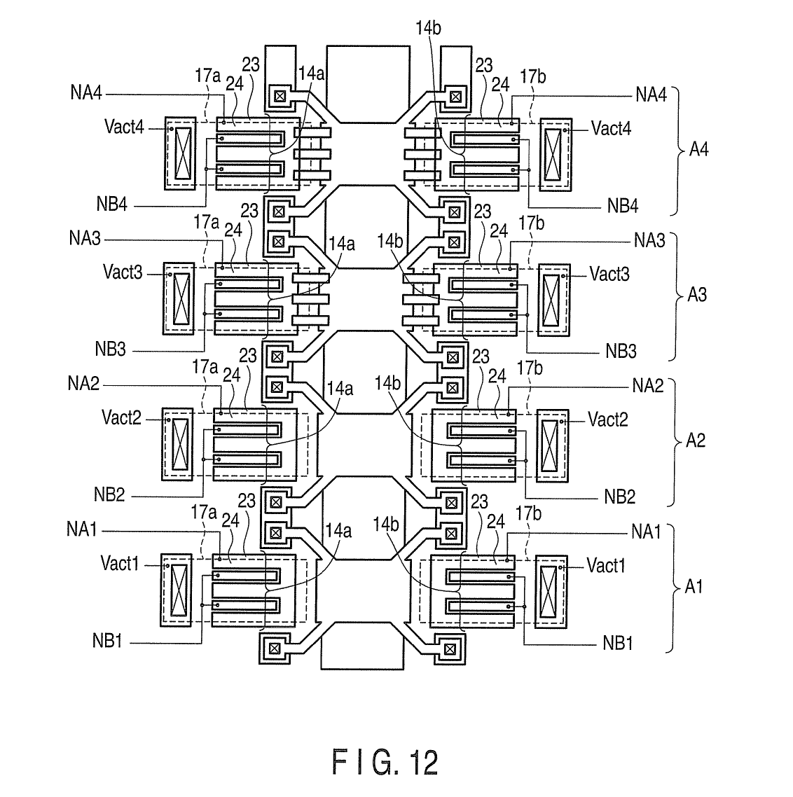

In FIG. 12, bias lines are added to the lower drive electrodes in the bank configuration in FIG. 10.

In programmable actuator A1, first parts 23 of lower drive electrodes 14a and 14b are biased to NA1, and second parts 24 of lower drive electrodes 14a and 14b are biased to NB1. Upper drive electrodes 17a and 17b are biased to Vact1.

In programmable actuator A2, first parts 23 of lower drive electrodes 14a and 14b are biased to NA2, and second parts 24 of lower drive electrodes 14a and 14b are biased to NB2. Upper drive electrodes 17a and 17b are biased to Vact2.

In programmable actuator A3, first parts 23 of lower drive electrodes 14a and 14b are biased to NA3, and second parts 24 of lower drive electrodes 14a and 14b are biased to NB3. Upper drive electrodes 17a and 17b are biased to Vact3.

In programmable actuator A4, first parts 23 of lower drive electrodes 14a and 14b are biased to NA4, and second parts 24 of lower drive electrodes 14a and 14b are biased to NB4. Upper drive electrodes 17a and 17b are biased to Vact4.

In such a bank configuration, the overlap areas between second parts 24 of lower drive electrodes 14a and 14b and upper drive electrodes 17a and 17b are sufficiently small. Therefore, for example, when only potentials NB1, NB2, NB3, and NB4 are biased, neither upper drive electrodes 17a nor 17b is attracted.

Accordingly, for example, when a capacitance is trimmed, the moving part is driven first by controlling potential differences between potentials NA, NA2, NA3, and NA4 and potential Vact, thereby to determine an optimum capacitance.

Thereafter, programmable actuators A1, A2, A3, and A4 are programmed by controlling the potential differences between potentials NA1, NA2, NA3, and NA4 and potential Vact. A procedure as described above is employed.

B. Modification Example

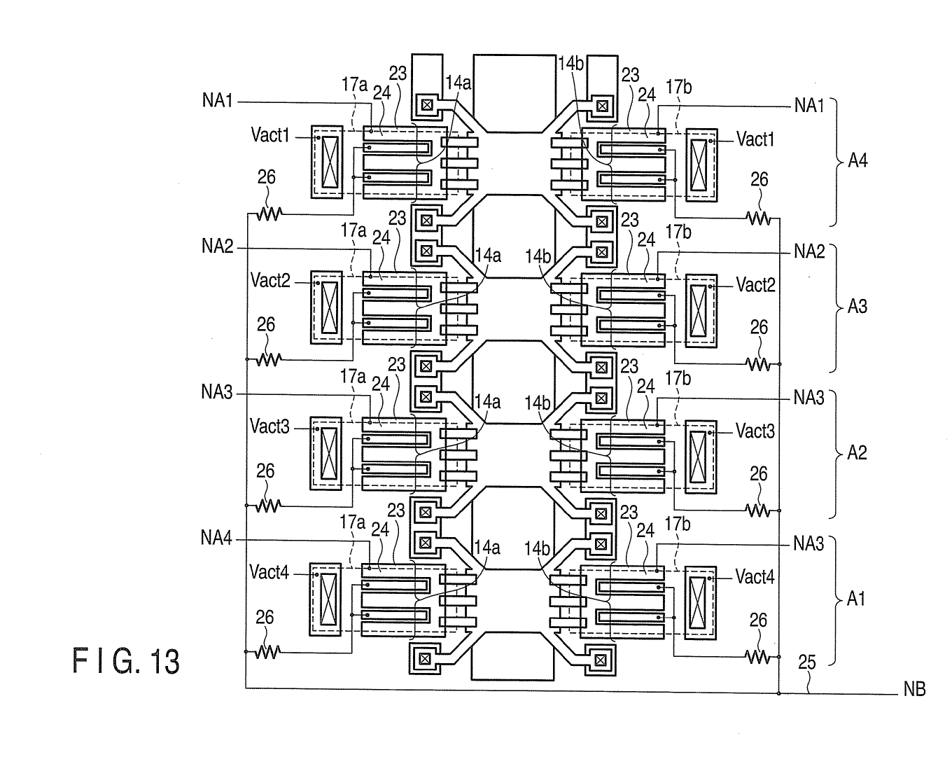

FIG. 13 illustrates a modification example of the bank configuration.

This modification example has a feature that a wire line 25 is shared in common by second parts 24 of lower drive electrodes 14a and 14b. By sharing bias line 25 in common between second parts 24 of lower drive electrodes 14a and 14b, wiring is prevented from becoming complex, and a wiring layout can be simplified.

In this configuration, for example, when to trim a capacitance, the moving part is driven first by controlling potential differences between potentials NA, NA2, NA3, and NA4 and potential Vact, thereby to determine an optimum capacitance.

Thereafter, with the optimum capacitance maintained for the bank, programmable actuators A1, A2, A3, and A4 are programmed by generating potential differences between potentials NA1, NA2, NA3, and NA4 and potential Vact.

For example, the optimum capacitance is assumed to correspond to a state that second parts 24 of lower drive electrodes 14a and 14b and upper drive electrodes 17a and 17b are in contact with each other in the programmable actuators A1 and A3 while second parts 24 of lower drive electrodes 14a and 14b and upper drive electrodes 17a and 17b are out of in contact with each other in programmable actuators A2 and A4.

At this time, while maintaining this state, a potential difference is generated between potential NB and potential Vact. Then, only programmable actuators A1 and A3 can be programmed. This is because programmable actuators A1 and A3 are in a state that second parts 24 of lower drive electrodes 14a and 14b and upper drive electrodes 17a and 17b are in contact with each other.

Meanwhile, this modification example causes a problem of a voltage drop due to short-circuiting between second parts 24 of lower drive electrodes 14a and 14b and upper drive electrodes 17a and 17b, when plural programmable actuators in one bank are programmed simultaneously.

Hence, resistor elements 26 are connected between bias line 25 shared in common and lower drive electrodes 14a and 14b.

The resistor elements 26 function to prevent a voltage drop when second parts 24 of lower drive electrodes 14a and 14b and upper drive electrodes 17a and 17b are short-circuited.

For example, consideration will now be taken into programming of the two programmable actuators A1 and A3.

In this case, when second parts 24 of lower drive electrodes 14a and 14b and upper drive electrodes 17a and 17b make in contact with each other first, second parts 24 of lower drive electrodes 14a and 14b of programmable actuator A3 then cause a voltage drop. Therefore, contact becomes unavailable between second parts 24 of lower drive electrodes 14a and 14b of programmable actuator A3 and upper drive electrodes 17a and 17b.

To prevent such a situation, even if second parts 24 of lower drive electrodes 14a and 14b of the programmable actuator A1 and upper drive electrodes 17a and 17b make in contact with each other first, the resistor elements 26 then prevent voltage drops at second parts 24 of lower drive electrodes 14a and 14b of programmable actuator A3.

In this manner, if contact timing between the second parts of the lower drive electrodes and the upper drive electrodes runs out when plural programmable actuators in one bank are programmed simultaneously, all the programmable actuators as programming targets can be programmed.

In the second embodiment, multiple values more than binary values can be programmed. Further, for example, capacitances can be digitally stored, and can therefore hardly change over time.

III. Third Embodiment

The third embodiment relates to a structure of lower drive electrodes.

A. Structure

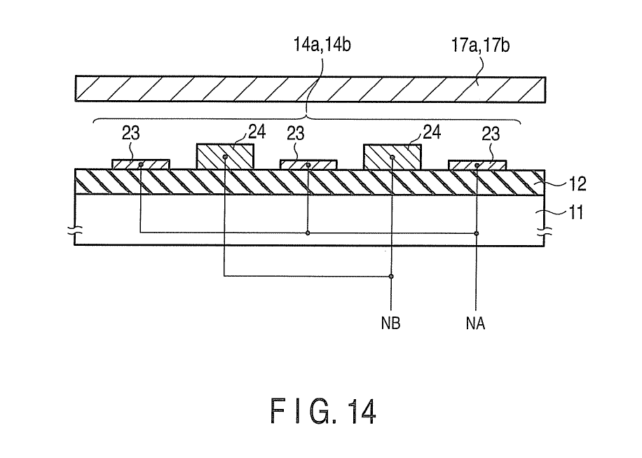

FIG. 14 illustrates lower/upper drive electrodes.

Semiconductor substrate 11 is, for example, a silicon substrate. Insulating layer 12 is provided on insulating layer 12. Insulating layer 12 is made of, for example, silicon oxide. Lower electrodes 14a and 14b are provided on insulating layer 12.

Lower drive electrodes 14a and 14b each comprise first part 23 and second part 24. First part 23 and second part 24 are arranged alternately. First part 23 is covered with insulating layer 15.

Lower drive electrode 14a has a plan shape as illustrated in FIG. 6, for example. Lower drive electrode 14b has a plan shape as illustrated in FIG. 7, for example.

Upper drive electrodes 17a and 17b opposite to lower drive electrodes 14a and 14b are provided above lower drive electrodes 14a and 14b.

The other parts of the configuration are the same as those of the first embodiment (see FIGS. 3 and 4).

In the present embodiment, first parts 23 of lower drive electrodes 14a and 14b are not covered with an insulating layer but may be covered with an extremely thin insulating layer such as a natural oxidation film. Alternatively, first parts 23 may be actively covered with an insulating layer.

B. Normal Operation

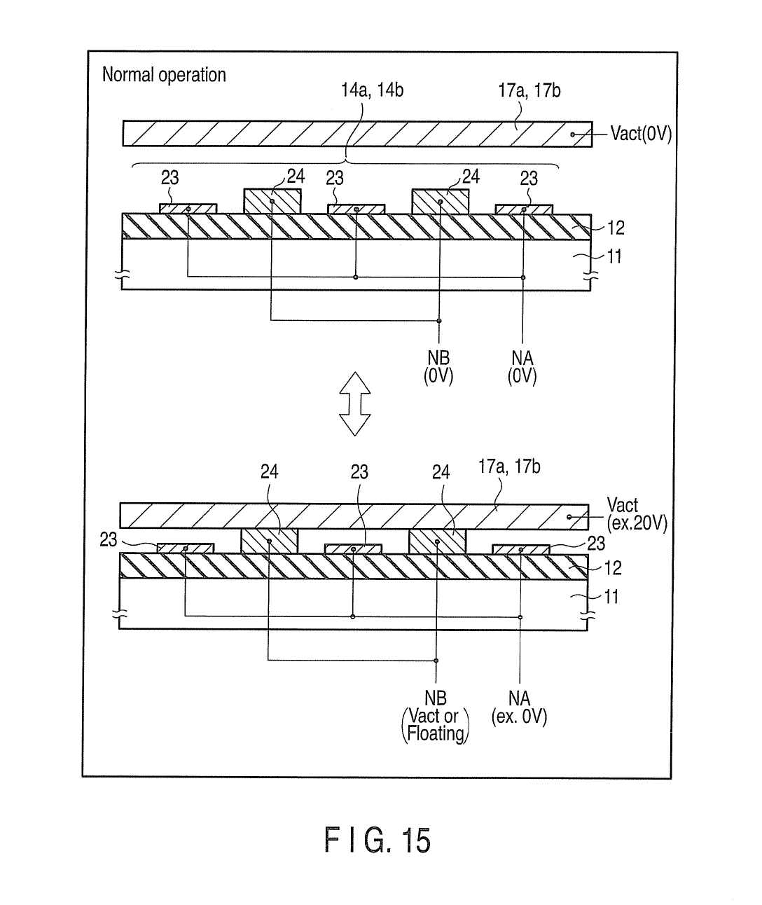

FIG. 15 illustrates a normal operation of the programmable actuators.

In an initial state, potential NA of first parts 23 of lower drive electrodes 14a and 14b is set to zero, and potential NB of second parts 24 of lower drive electrodes 14a and 14b is also set to zero. Potential Vact of upper drive electrodes 17a and 17b is set to zero.

At this time, a distance between the lower and upper signal electrodes is maximum. Therefore, for example, the programmable actuator as a programmable capacitor has a minimum capacitance and as a programmable switch enters into an off-state.

In a drive state of driving a moving part, for example, potential NA of first parts 23 of lower drive electrodes 14a and 14b is set to zero, and potential NB of second parts 24 of lower drive electrodes 14a and 14b is set to Vact or floating. Potential Vact of upper drive electrodes 17a and 17b is set to 20 V.

At this time, an electrostatic attractive force is generated between first parts 23 of lower drive electrodes 14a and 14b and upper drive electrodes 17a and 17b. Therefore, upper drive electrodes 17a and 17b are attracted to first parts 23 of lower drive electrodes 14a and 14b.

In addition, second parts 24 of lower drive electrodes 14a and 14b function as a stopper, and upper drive electrodes 17a and 17b are therefore not brought into contact with first parts 23 of lower drive electrodes 14a and 14b.

As a result, the distance between the upper and lower signal electrodes is minimized or becomes zero (contact state). Therefore, for example, the capacitance of the programmable actuator as a programmable capacitor takes a maximum value, and the programmable actuator as a programmable switch enters into an on-state.

The operation described above can be stably performed plural times, by controlling values of NA, NB, and Vact.

In the drive state of driving the moving part, for example, potential NA of first parts 23 of lower drive electrodes 14a and 14b may be set to 20 V, and potential NB of second parts 24 of lower drive electrodes 14a and 14b and potential Vact of upper drive electrodes 17a and 17b may be set to zero.

C. Programming Operation

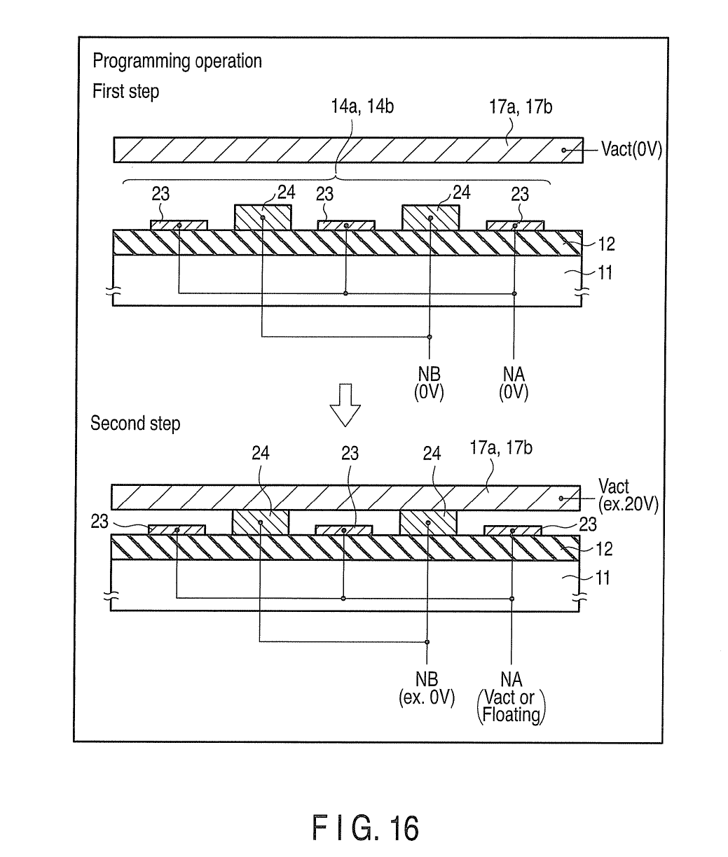

FIG. 16 illustrates a programming operation of the programmable actuator.

In a first step, potential NA of first parts 23 of lower drive electrodes 14a and 14b is set to zero, and potential NB of second parts 24 of lower drive electrodes 14a and 14b is set to zero. Potential Vact of upper drive electrodes 17a and 17b is set to zero.

At this time, the distance between the lower and upper signal electrodes is maximized. Therefore, for example, a capacitance of the programmable actuator as a programmable capacitor takes a minimum value, and the programmable actuator as a programmable switch enters into an off-state.

In a second step, for example, potential NA of first parts 23 of lower drive electrodes 14a and 14b is set to Vact or floating, and potential NB of second parts 24 of lower drive electrodes 14a and 14b is set to zero. Potential Vact of upper drive electrodes 17a and 17b is set to 20 V.

At this time, an electrostatic attractive force is generated between first parts 23 of lower drive electrodes 14a and 14b and upper drive electrodes 17a and 17b. Therefore, upper drive electrodes 17a and 17b are attracted to second parts 24 of lower drive electrodes 14a and 14b.

In this state, such a current that partially melts both second parts 24 of lower drive electrodes 14a and 14b and upper drive electrodes 17a and 17b by heat generation is flowed between second parts 24 and electrodes 17a and 17b. If this current is stopped, second parts 24 of lower drive electrodes 14a and 14b and upper drive electrodes 17a and 17b are cooled, and second parts 24 and electrodes 17a and 17b are both permanently fixed.

As a result, for example, when the capacitance of the programmable actuator as a programmable capacitor takes a maximum value or when the programmable actuator as a programmable switch is in the on-state, the moving part is fixed.

Alternatively, in the second step, potential NB of second parts 24 of lower drive electrodes 14a and 14b may be set to 20 V, and potential NA of first parts 23 of lower drive electrodes 14a and 14b and potential Vact of upper drive electrodes 17a and 17b may be set to zero.

Also alternatively, in the second step, a potential difference may be given between first parts 23 of lower drive electrodes 14a and 14b and upper drive electrodes 17a and 17b.

Further, permanent fixation between second parts 24 of lower drive electrodes 14a and 14b and upper drive electrodes 17a and 17b may be achieved by van der Waals's force or Casimir force in place of heat generation using an electric current.

According to the third embodiment, the first and second parts of the lower drive electrodes need not be covered with an insulating layer. Therefore, manufacturing costs can be reduced by reducing the number of steps.

IV. Fourth Embodiment

The fourth embodiment also relates to the structure of the lower drive electrodes.

A. Structure

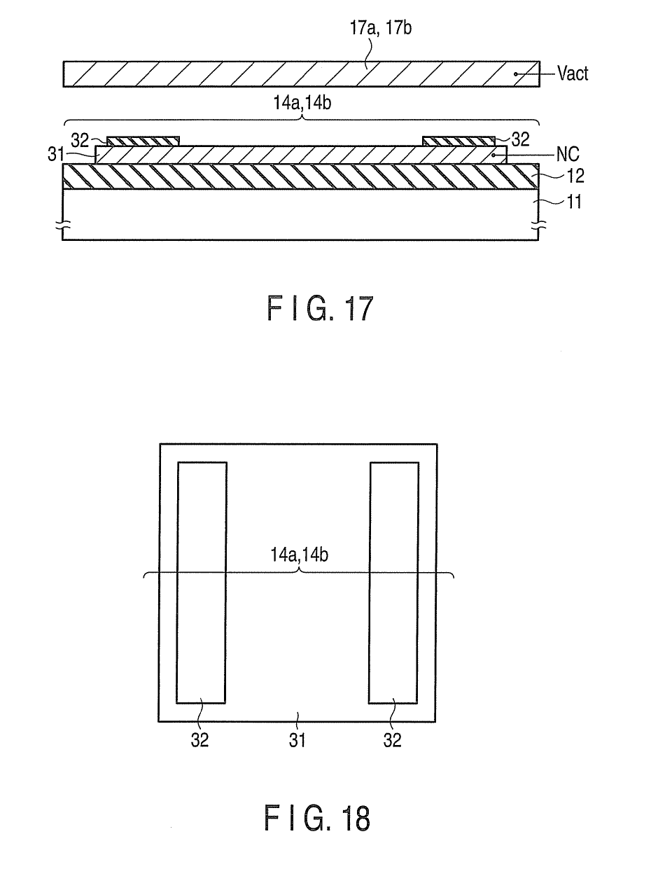

FIG. 17 illustrates lower/upper drive electrodes.

Semiconductor substrate 11 is, for example, a silicon substrate. Insulating layer 12 is provided on insulating layer 12. Insulating layer 12 is made of, for example, silicon oxide. Lower electrode 31 (14a, 14b) is provided on insulating layer 12.

Insulating layer 32 is provided partially on lower drive electrode 31.

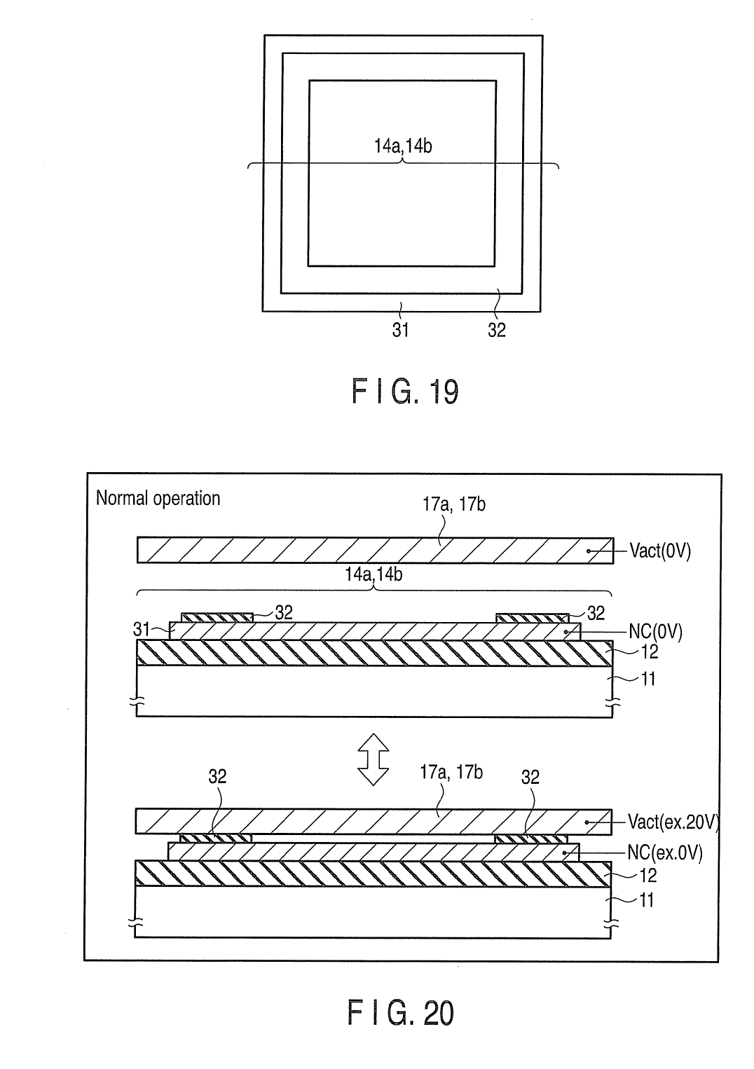

Lower drive electrode 31 has a rectangular plan shape, as illustrated in FIGS. 18 and 19, for example. Insulating layer 32 has a plan shape which can be expressed by two lines arranged side by side as illustrated in FIG. 18, for example, or has an annular plan shape as illustrated in FIG. 19, for example.

Upper drive electrodes 17a and 17b opposite to lower drive electrode 31 are provided above lower drive electrode 31.

The other parts of the configuration are the same as those of the first embodiment (see FIGS. 3 and 4).

B. Normal Operation

FIG. 20 illustrates a normal operation of the programmable actuator.

In an initial state, potential NC of lower drive electrode 31 (14a, 14b) is set to zero, and potential Vact of upper drive electrodes 17a and 17b is also set to zero.

At this time, a distance between the lower and upper signal electrodes is maximum. Therefore, for example, the programmable actuator as a programmable capacitor has a minimum capacitance, and as a programmable switch enters into an off-state.

In a drive state of driving a moving part, for example, potential NC of the lower drive electrode 31 is set to zero, and potential Vact of upper drive electrodes 17a and 17b is set to 20 V.

At this time, an electrostatic attractive force is generated between lower drive electrode 31 and upper drive electrodes 17a and 17b. Therefore, upper drive electrodes 17a and 17b are attracted to lower drive electrode 31.

In addition, insulating layer 32 on lower drive electrode 31 functions as a stopper, and upper drive electrodes 17a and 17b are therefore not brought into contact with lower drive electrode 31.

As a result, the distance between the upper and lower signal electrodes is minimized or becomes zero (contact state). Therefore, for example, the capacitance of the programmable actuator as a programmable capacitor takes a maximum value, and as the programmable actuator a programmable switch enters into an on-state.

The operation described above can be stably performed plural times, by controlling values of NC and Vact.

In the drive state of driving the moving part, for example, potential NC of the lower drive electrode 31 may be set to 20 V, and potential Vact of upper drive electrodes 17a and 17b may be set to zero.

C. Programming Operation

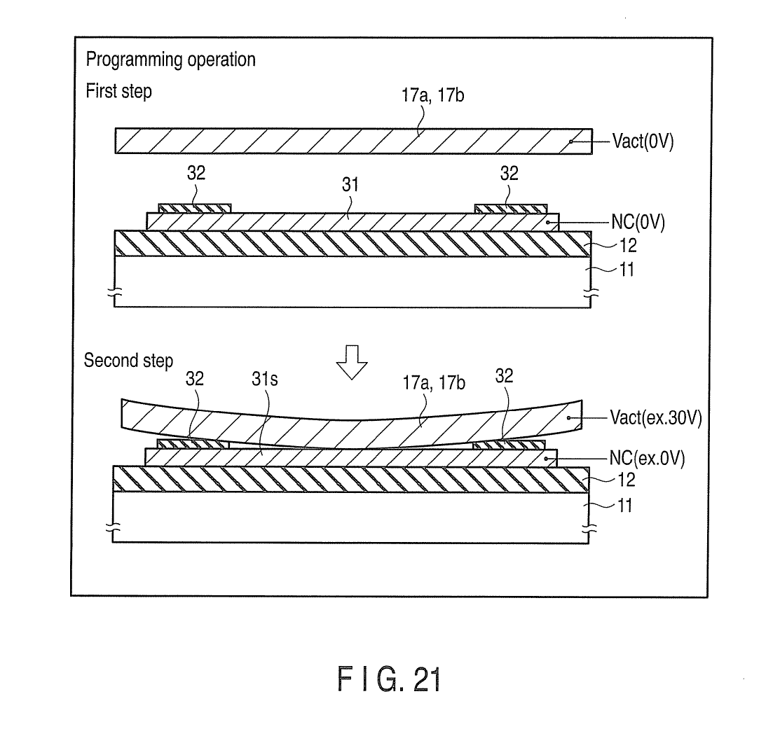

FIG. 21 illustrates a programming operation of the programmable actuator.

In a first step, potential NC of lower drive electrode 31 (14a, 14b) is set to zero, and potential Vact of upper drive electrodes 17a and 17b is set to zero.

At this time, the distance between the lower and upper signal electrodes is maximized. Therefore, for example, a capacitance of the programmable actuator as a programmable capacitor takes a minimum value, and the programmable actuator as a programmable switch enters into an off-state.

In a second step, for example, potential CN of lower drive electrode 31 is set to zero. Potential Vact of upper drive electrodes 17a and 17b is set to 30 V.

At this time, an electrostatic attractive force is generated between lower drive electrode 31 and upper drive electrodes 17a and 17b. Therefore, upper drive electrodes 17a and 17b are attracted to lower drive electrode 31.

A potential difference generated between lower drive electrode 31 and upper drive electrodes 17a and 17b in the second step is greater than a potential difference generated between lower drive electrode 31 and upper drive electrodes 17a and 17b in the first step. Therefore, upper drive electrodes 17a and 17b are bent and brought into contact with lower drive electrode 31.

In this state, such a current that partially melts both lower drive electrode 31 and upper drive electrodes 17a and 17b by heat generation is flowed between both the lower and upper drive electrodes. If this current is stopped, lower drive electrode 31 and upper drive electrodes 17a and 17b are cooled, and both the lower and upper drive electrodes are both permanently fixed.

As a result, for example, when the capacitance of the programmable actuator as a programmable capacitor takes a maximum value or when the programmable actuator as a programmable switch is in the on-state, the moving part is fixed.

Alternatively, in the second step, potential NC of lower drive electrode 31 may be set to 30 V, and potential Vact of upper drive electrodes 17a and 17b may be set to zero.

Further, permanent fixation between lower drive electrode 31 and upper drive electrodes 17a and 17b may be achieved by van der Waals's force or Casimir force in place of heat generation using an electric current.

According to the fourth embodiment, lower drive electrode 31 is not divided into first and second parts. Besides, the normal operation and the programming operation are distinguished from each other, depending on size of a potential applied to the lower electrode.

V. Fifth Embodiment

The fifth embodiment relates to a programmable switch.

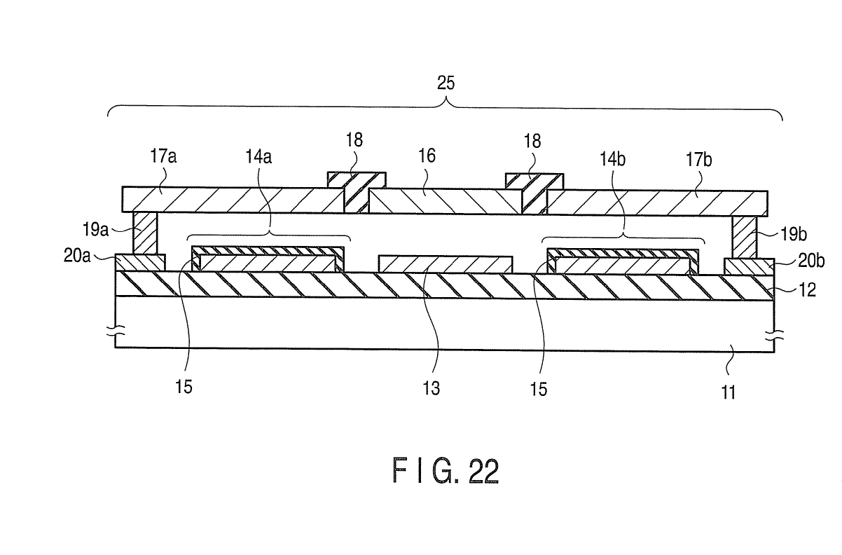

FIG. 22 illustrates a programmable switch. Semiconductor substrate 11 is, for example, a silicon substrate. Insulating layer 12 is provided on insulating layer 12. Insulating layer 12 is made of, for example, silicon oxide.

Lower signal electrode 13, lower drive electrodes 14a and 14b, and conductive layers 20a and 20b are provided on insulating layer 12.

Lower drive electrodes 14a and 14b each comprise first and second parts, as in the first embodiment. Lower drive electrode 14a has a plan shape as illustrated in FIG. 6, for example. Lower drive electrode 14b has a plan shape as illustrated in FIG. 7, for example.

Upper signal electrode 16 opposite to lower signal electrode 13 is provided above lower signal electrode 13. Upper drive electrodes 17a and 17b opposite to lower drive electrodes 14a and 14b are provided above lower drive electrodes 14a and 14b.

Upper signal electrode 16 and upper drive electrodes 17a and 17b are jointed mutually by an insulator 18. Moving part 25 is constituted by the upper signal electrode 16, upper drive electrodes 17a and 17b, and insulator 18 combining these electrodes.

The other parts of the configuration are the same as those of the first embodiment (see FIGS. 3 to 5).

The fifth embodiment differs from the first embodiment in that no insulating layer 15 exists on lower signal electrode 13.

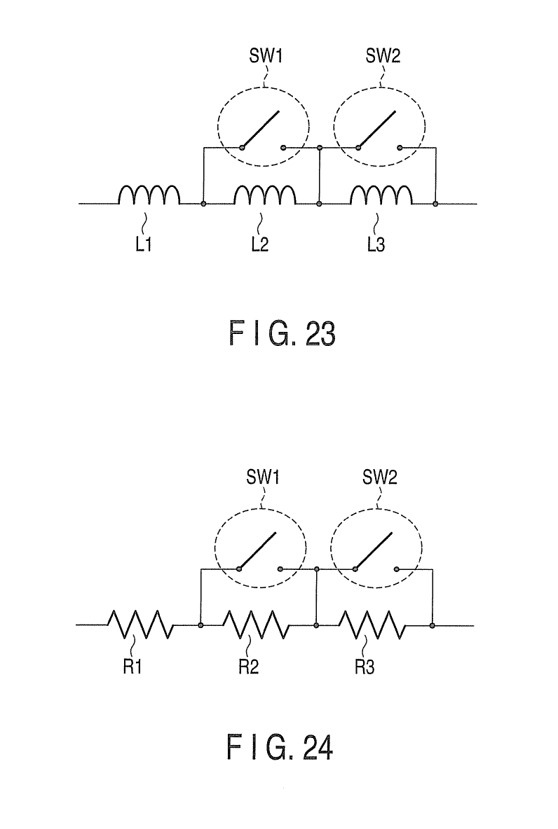

FIG. 23 illustrates a first example of a system using programmable switches.

This system establishes a programmable inductor which programs an inductance.

Programmable switches SW1 and SW2 have, for example, a structure as illustrated in FIG. 22.

In this system, programmable switches SW1 and SW2 are programmed to switch on/off, thereby to allow selection of one from four inductances of L1, L1+L2, L1+L3, and L1+L2+L3.

FIG. 24 illustrates a second example of the system using programmable switches.

This system establishes a programmable resistor which programs resistances.

Programmable switches SW1 and SW2 have, for example, a structure as illustrated in FIG. 22.

In this system, programmable switches SW1 and SW2 are programmed to switch on/off, thereby to allow selection of one from four resistances of R1, R1+R2, R1+R3, and R1+R2+R3.

VI. Sixth Embodiment

The sixth embodiment relates to usage in which a part of plural programmable capacitors in a capacitance bank is used as a variable capacitor after shipping while the other part thereof is used as a trimmer capacitor.

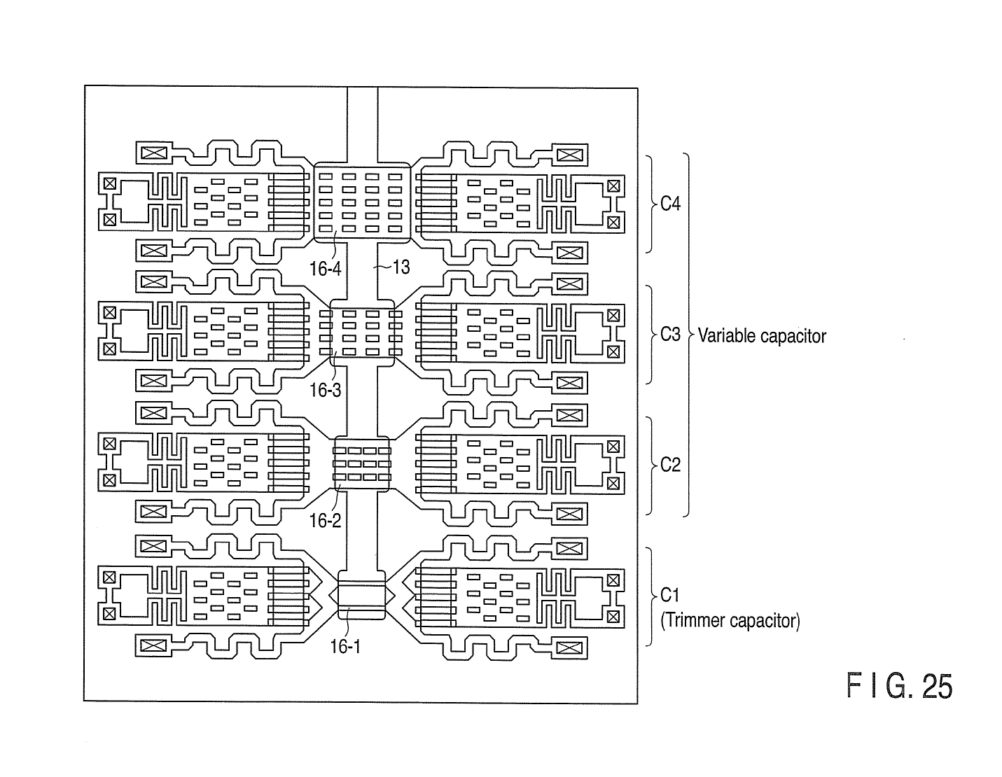

FIG. 25 illustrates an example of the capacitance bank.

For example, one of four programmable capacitors C1, C2, C3, and C4 is used as a trimmer capacitor which trims variations of capacitances. The other remaining three capacitors are used as variable capacitors.

3. Others

In the programmable actuator or actuators in each embodiment, the moving part is driven mainly before shipping (for example, in a wafer state). Therefore, a power supply to drive the moving part can be provided outside the chip (semiconductor substrate), e.g., from a tester.

In addition, the drive circuit which drives the programmable actuator or actuators may be provided either inside or outside the chip. When the drive circuit is provided outside the chip, a drive circuit which drives the programmable actuator or actuators need not be provided inside the chip. Accordingly, manufacturing costs can be reduced.

4. Application Example

The programmable actuator or actuators in each embodiment are applicable to an element, such as a trimmer capacitor, which trims a capacitance and/or a resistance before shipping.

For example, in trimming of a frequency in a crystal oscillator or keyless entry system, various capacitances are generated, and an optimum value is determined from among the generated values. Thereafter, the optimum value can be programmed.

Also, the programmable actuator or actuators in each embodiment are applicable to trimming of a frequency so as to comply with standards for wireless communication cards.

Further, the programmable actuator or actuators in each embodiment are applicable not only to trimming but also to a programmable capacitor which programs a capacitance, a programmable resistor which programs a resistance, a programmable inductor which programs an inductances, and a programmable switch which programs switching on/off of a switch.

According to the embodiments, an electrostatic MEMS actuator with a program function can be established.

While certain embodiments have been described, these embodiments have been prestored by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A programmable actuator comprising:
a moving part with a first drive electrode;
a second electrode which is placed opposite to the first electrode, and which has a first part and a second part;
a first drive circuit which is capable of actuating the moving part in such a way that the first drive electrode is not in contact with the second part by generating a first electric potential difference between the first part and the first drive electrode; and
a second drive circuit which is capable of permanently fixing the moving part in such a way that the first drive electrode is in contact with the second part by generating a second electric potential difference between the second part and the first drive electrode.

2. The actuator of claim 1, further comprising
a first signal electrode;
a second signal electrode which is placed opposite to the first electrode; and
an insulator which joints the first signal electrode with the first drive electrode, wherein the moving part includes the first signal electrode and the insulator.

3. The actuator of claim 2,
wherein the first and second signal electrodes comprise two electrodes of a programmable capacitor.

4. The actuator of claim 3,
wherein a capacitance value of the programmable capacitor is fixed when the first and second drive electrodes are fixed.

5. The actuator of claim 2,
wherein the first and second signal electrodes comprise two electrodes of a programmable switch.

6. The actuator of claim 5,
wherein the programmable switch keeps an on-state when the first and second drive electrodes are fixed.

7. The actuator of claim 1,
wherein the first part and the second part of the second drive electrode have upper surfaces opposite to the first electrode, the upper surface of the first part is covered by an insulating layer, and the upper surface of the second part is not covered by an insulating layer.

8. The actuator of claim 7,
wherein the first drive electrode has a first potential, the first part has a second potential different from the first potential, the second part has one of the first potential and a floating, and the second part is apart from the first drive electrode, when the moving part is driven in a normal operation.

9. The actuator of claim 7,
wherein the first drive electrode has a first potential, the first part and the second part has a second potential different from the first potential, and the second part is in contact with the first drive electrode, when the moving part is fixed in a programming operation.

10. The actuator of claim 1,
wherein the second part of the second drive electrode is closer to the first drive electrode than the first part of the second drive electrode.

11. The actuator of claim 10,
wherein the first drive electrode has a first potential, the first part has a second potential different from the first potential, the second part has one of the first potential and a floating, and the second part is in contact with the first drive electrode, when the moving part is driven in a normal operation.

12. The actuator of claim 10,
wherein the first drive electrode has a first potential, the first part has one of the first potential and a floating, the second part has a second potential different from the first potential, and the second part is in contact with the first drive electrode, when the moving part is fixed in a programming operation.

13. A programming method of the actuator of claim 1 comprising:
flowing a current between the first drive electrode and the second part in such a way that the first drive electrode is in contact with the second part; and
fixing the moving part by fixing the first drive electrode with the second part.

14. The method of claim 13,
wherein the fixing of the moving part is executed by one of melting of the first drive electrode and the second part of the second drive electrode, a van der Waals's force, and a casimir force.

15. A capacitor bank configuration comprising:
programmable actuators each including the actuator of claim 1,
wherein each of the actuators stores 1 bit data.

16. The capacitor bank configuration of claim 15,
wherein capacitance values of the actuators are different from each other, and each of the capacitance values has one of Cmin/Cmax, 2×Cmin/Cmax, . . . and 2n−1×Cmin/Cmax, where n is a number of the actuators, Cmin is one of the 1 bit data, and Cmax is the other of the 1 bit data.

17. The capacitor bank configuration of claim 15, further comprising:
a bias line which is shared by the second parts of the actuators; and
resistance elements each connected between the bias line and one of the second parts.

18. A programmable actuator comprising:
a moving part with a first drive electrode;
a second electrode which is placed opposite to the first electrode;
an insulating layer which is provided partially on a surface of the second drive electrode, the surface being placed opposite to the first drive electrode; and
a drive circuit which is capable of actuating the moving part in such a way that the first drive electrode is not in contact with the second drive electrode by generating a first electric potential difference between the first and second drive electrodes, and which is capable of fixing the moving part in such a way that the first drive electrode is in contact with the second drive electrode by generating a second electric potential difference larger than the first electric potential difference between the first and second drive electrodes.

19. The actuator of claim 18,
wherein the first drive electrode has a first potential, the second drive electrode has a second potential different from the first potential, and the first drive electrode is apart from the second drive electrode, when the moving part is driven in a normal operation.

20. The actuator of claim 18,
wherein the first drive electrode has a first potential, the second drive electrode has a second potential different from the first potential, and the first drive electrode is in contact with the second drive electrode, when the moving part is fixed in a programming operation.
